(19) United States
(12) Patent Application Publication
(10) Pub. No.: US 2007/0214578 A1
(43) Pub. Date: Sep. 20, 2007

(54) Process of bleaching fabric

(76) Inventors: Giulia Ottavia Bianchetti, Rome (IT); Stefano Resta, Genzano-Rome (IT); Giovanni Grande, Rome (IT)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/715,519

(22) Filed: Mar. 8, 2007

(30) Foreign Application Priority Data
Mar. 17, 2006 (EP) 06 111 346.0

(51) Int. Cl. C11D 3/00

(52) U.S. Cl. 8/115.51

(57) ABSTRACT

The present invention relates to a process of treating fabrics with bleaching compositions. Said compositions are suitable for use in laundry applications; they are particularly appropriate to be used as a laundry pretreater and to a process of pretreating fabrics. More particularly, the present invention relates to a process of treating fabrics with a liquid or solid, aqueous or non-aqueous composition, said composition comprising chlorine dioxide and a peroxygen bleach.

### TECHNICAL FIELD

The present invention relates to a process of treating fabrics with bleaching compositions. Said compositions are intended for use in various laundry applications. They are particularly appropriate to be used as laundry pretreater and to a process of pretreating fabrics.

### BACKGROUND OF THE INVENTION

Bleach-containing compositions for bleaching fabrics are well known in the art. They have been extensively described in laundry applications as laundry detergents, laundry additives or laundry pretreaters.

Indeed, it is known to use such bleach-containing compositions in laundry pretreatment applications to boost the removal of encrusted stains/soils and “problem” stains, such as grease, coffee, tea, grass, mud/clay-containing soils, which are otherwise particularly difficult to remove by typical machine washing.

However, a drawback associated with such bleach-containing compositions is that they do not always have good bleaching performance and, moreover, said bleach-containing compositions may results in dye damage, especially when used in pretreatment applications under stressed conditions, e.g. when applied directly onto the fabric and left to act on said fabric for prolonged periods of time before washing said fabrics.

Bleaching compositions can be classified into peroxide bleaching compositions and hypochlorite bleaching compositions. Peroxygen bleaches have the advantage over hypochlorite bleaching compositions that are generally considered as being somewhat safer to fabrics, in particular on colored fabric.

Bleaching performance and fabric color safety are somewhat conflicting requirements, but both are desirable in a composition for treating fabrics. Although currents bleaching compositions provide good bleaching performance when used to treat a soiled fabric, there is still substantial room for further improvement regarding bleaching performance whilst providing good color safety.

Accordingly, the present invention solves the long-standing need for an effective, dye-safe bleaching composition with good stains/soils removal performance. Thus, it is an object of the invention to provide a process of treating a fabric which provides improved bleaching performances and fabrics safety. It has now been found that this can be achieved by formulating a composition containing chlorine dioxide and peroxygen bleach. More particularly, it has been found that the use of said composition for treating a fabric has excellent bleach performance on bleachable stains. Moreover, a further advantage associated to the use of said composition in laundry application, is that it provides good colour safety performance.

Chlorine dioxide is a well-known disinfecting and sterilizing agent. However, because it is gaseous at room temperature and atmospheric pressure, chlorine dioxide has not achieved widespread use except where its gaseous nature can be used to effect, for example, in the treatment of water supplies.

Despite this problem, chlorine dioxide bleach-containing compositions have been described in the art, the use of chlorine dioxide in low concentrations has long been recognized as useful for the treatment of odours and microbes, notably as a hard surface cleaner.

WO 2005/035708 discloses a method for cleaning items comprising a chlorine dioxide composition, the chlorine dioxide and the laundry detergent are added to the cleaning apparatus with a water source at the same time.

JP 59-157,375 relates to a method for cleaning wet hand towels using stabilized chlorine dioxide mixed with water in the final rinse cycle.

### SUMMARY OF THE INVENTION

The present invention encompasses a process of treating a fabric with a composition comprising chlorine dioxide and peroxygen bleach, preferably hydrogen peroxide or a water soluble source thereof.

The present invention also relates to the use of a composition comprising chlorine dioxide and a peroxygen bleach in laundry application, and more preferably for a use in laundry pretreatment application.

### DETAILED DESCRIPTION OF THE INVENTION

The present invention encompasses process of treating fabrics with a composition comprising chlorine dioxide and a peroxygen bleach.

The present invention is based on the finding that the use of chlorine dioxide in combination with peroxygen bleach provides excellent bleaching performance when used in a laundry application and, of the same time, provides good colour safety performance.

The composition comprising chlorine dioxide and a peroxygen bleach can be a liquid or solid, aqueous or non-aqueous composition. The composition according to the invention can be formulated as powders, granules, liquids, pastilles or tablets. Liquid bleaching compositions are preferred herein for convenience of use.

The compositions according to the present invention are preferably formulated as aqueous compositions. In a preferred embodiment, the composition according to the invention is a liquid aqueous bleaching composition. Therefore, the compositions of the present invention preferably comprise water, more preferably may comprise water in an amount of from 60% to 98%, even more preferably of from 80% to 97% and most preferably 85% to 97% by weight of the total composition.

Preferred peroxygen bleach is hydrogen peroxide, or a water soluble source thereof, or mixtures thereof. As used herein a hydrogen peroxide source refers to any compound which produces hydrogen peroxide when said compound is in contact with water. Preferably the composition contains hydrogen peroxide or a water soluble source thereof, more preferably the composition, according to the invention, contains hydrogen peroxide.

Suitable water-soluble sources of hydrogen peroxide for use herein include percarbonates, persilicates, persulphates such as monopersulfate, perborates, peroxyacids such as diperoxydodecandioic acid (DPDA), magnesium perphtalic acid, perlauric acid, perbenzoic and alkylperbenzoic acids, hydroperoxides, aliphatic and aromatic diacyl peroxides, and mixtures thereof. Preferred peroxygen bleaches herein are hydrogen peroxide, hydroperoxide and/or diacyl peroxide. Suitable hydroperoxides for use herein are tert-butyl hydroperoxide, cumyl hydroperoxide, 2,4,4-trimethylpentyl-2-hydroperoxide, di-isopropylbenzene-monohydroperoxide, tert-amyl hydroperoxide and 2,5-dimethyl-hexane-2,5-dihydroperoxide. Suitable aliphatic diacyl peroxides for use herein are dilauroyl peroxide, didecanoyl peroxide, dimyristoyl peroxide, or mixtures thereof. Suitable aromatic diacyl peroxide for use herein is for example benzoyl peroxide.

Typically, the compositions suitable to be used herein comprise from 0.01% to 20% by weight of the total composition of said peroxygen bleach, preferably from 0.1% to 10% and most preferably from 1% to 7%.

By “treating a fabric”, it is meant herein cleaning and/or bleaching and/or disinfecting said fabric. This can be done either in a so-called “pretreatment mode”, where a bleaching composition, as defined herein, is applied in its neat form onto said fabrics before the fabrics are washed and/or rinsed; or in a “soaking mode” where a composition, as defined herein, is first diluted or dissolved in an aqueous bath then the fabrics are immersed and soaked in the bath, before they are rinsed; or in a “through the wash mode”, where a composition, as defined herein, is added on top of a wash liquor formed by dissolution or dispersion of a typical laundry detergent. It is essential, that the fabrics have to be rinsed after they have been contacted with said composition, before said composition has completely dried off.

The compositions according to the present invention can be used in diluted form in a laundry operation. By “in diluted form”, it is meant herein that the compositions for the bleaching of fabrics according to the present invention may be diluted by the user, preferably with water. Such dilution may occur for instance in hand laundry applications as well as by other means such as in a washing machine. Said compositions can be diluted up to 500 times, preferably from 5 to 200 times and more preferably from 10 to 80 times.

In a preferred embodiment, the composition comprising chlorine dioxide and peroxygen bleach is used in a process of pretreat fabric.

By “in its neat form”, it is to be understood that the compositions described herein are applied onto the fabrics to be treated without undergoing any dilution prior the application by the user.

By “washing”, it is to be understood herein that the fabrics are contacted with a conventional detergent composition, preferably comprising at least one surface active agent in an aqueous bath, this washing may occur by means of a washing machine or simply by hands. In a preferred embodiment, the washing step according to the present invention is performed in a washing machine. The conventional laundry detergent may be delivered into the washing machine either by charging the dispenser drawer of the washing machine with the detergent or by directly charging the drum of the washing machine with the detergent. By “conventional laundry detergent” it is meant herein, a laundry detergent composition currently available on the market. Preferably, said conventional laundry detergent comprises at least one surface active agent (“surfactant” as described herein below). Said laundry detergent compositions may be formulated as powders, liquids or tablets. Suitable laundry detergent compositions are for example DASH futur®, DASH essential®, DASH liquid®, ARIEL tablets® and other products sold under the trade names ARIEL® or TIDE®.

By “fabrics”, it is meant herein any type of fabrics including clothes, curtains, drapes, bed linens, bath linens, table cloths, sleeping bags, tents and the like. Fabrics to be treated as described herein include natural fabrics (e.g., fabrics made of cotton, viscose, and linen), synthetic fabrics such as those made of polymeric fibers of synthetic origin as well as those made of both natural and synthetic fibers. In a preferred embodiment according to the present invention the fabrics treated are coloured fabrics, i.e., the fibres of the fabric have been dyed.

In a more preferred embodiment, the present invention encompasses a process of treating a fabric which comprises the steps of applying said fabric with a composition containing chlorine dioxide and peroxygen bleach, in its neat form and allowing said composition to remain in contact with said fabric for an effective amount of time, before said fabric is washed and/or rinsed. Preferably this composition is a liquid composition.

The composition may remain in contact with said fabric for an effective amount of time, and typically for a period of 1 minute to 24 hours, preferably 1 minute to 1 hour and more preferably 5 minutes to 30 minutes. More preferably, the composition remains in contact with the fabric without leaving said composition to dry onto said fabric. Optionally, when the fabric is soiled with encrusted stains/soils which otherwise would be relatively difficult to remove, the compositions may be rubbed and/or brushed more or less intensively, for example, by means of a sponge or a brush or simply by rubbing two pieces of fabric each against the other. Preferably, the present invention encompasses the use of a liquid composition comprising peroxygen bleach and chlorine dioxide for pretreating a soiled fabric.

Furthermore, the compositions according to the invention may be used in so-called commercial laundry applications. Indeed, bleaching compositions herein may be used as the sole active composition in a large scale commercial bleaching process, or in combination with a detergent as a bleach booster composition (bleach additive function), or added prior or after the main detergent in a commercial laundry cleaning operation in a commercial laundry washing machine or a tunnel laundry washing machine.

Upon application onto fabrics, the chlorine dioxide present in the liquid bleaching composition may results from chlorine dioxide, which is already present in the composition, or may be produced immediately prior to the application, i.e. in the dispensing step, for example by mixing in a premix chamber of the container wherein said composition is packaged in, or in the stream of liquid dispensed from the container wherein said composition is packaged, or may be produced directly on the fabrics, i.e. “in-situ”.

A stabilized raw material containing chlorine dioxide (such as for example the Carnebon 200® from International Dioxcide Inc.) can be use to formulate a composition containing chlorine dioxide. This raw material is added to a liquid aqueous composition, in the purpose of obtaining a composition containing stabilized chlorine dioxide.

There are several ways of obtaining chlorine dioxide in-situ or immediately prior to the application onto fabrics according to the process of the invention.

The chlorine dioxide can be generated by acidification of a chlorine dioxide precursor, such as sodium chlorite (NaClO₂) or sodium chlorate (NaClO₃), with an acid source:

5ClO₂⁻+4H⁺→4ClO₂+2H₂O+Cl⁻

NaClO₃+1/2H₂O₂+H₂SO₄→ClO₂+NaHSO₄+H₂O+1/2O₂

Chlorine dioxide can also be obtained by other means such as, for example, the oxidation of sodium chlorite by persulfate:

2NaClO₂+Na₂S₂O₈→2ClO₂+2Na₂SO₄;

Chlorine dioxide can also be obtained by the reduction of chloric acids (HClO₃) with oxalic acid:

2HClO₃+H₂C₂O₄→2ClO₂+2CO₂+2H₂O;

According to the present invention, the preferred way of obtaining chlorine dioxide is to generate chlorine dioxide by acidification of a chlorine dioxide precursor, such as sodium chlorite (NaClO₂) or sodium chlorate (NaClO₃), with an acid source, such as for example citric acid (HOC(COOH)(CH₂COOH)₂) or oxalic acid (H₂C₂O₄). In a more preferred way, the chlorine dioxide is generated by acidification of sodium chlorite (NaClO₂) with an acid source, such as for example citric acid.

In a preferred embodiment, the composition according to the invention comprises from 0.0001% to 10% by weight of the total composition of chlorine dioxide, preferably from 0.001% to 2% by weight and more preferably from 0.01% to 0.5%.

The compositions herein can be packaged in a variety of containers including conventional bottles, bottles equipped with roll-on, sponge, brusher or sprayers, wipes or multi-compartments container package.

In a preferred embodiment, the composition herein is applied onto said fabric by combining two components, these components are packed in such way as to be kept physically separated from each other prior to their use, as for example a combination of a wipe and a liquid activator composition. In a preferred embodiment, said composition is applied onto said fabric by means of a wipe, the wipe is a pre-moistened or a pre-loaded wipes. A liquid activator is applied to the wipe in order to produce the chlorine dioxide at the time of the addition.

In a more preferred embodiment, in a multi-compartment, preferably a two compartments package. In all such embodiments the key measure is that the reactants are combined only at the time of cleaning.

In a more preferred embodiment according to the invention, the package is a multi-compartment container, preferably a two compartments container. The package is designed to keep the composition in two components, i.e. in a first and in a second component.

There are several ways of mixing the first and the second components. This mixing can be done within a mixing zone adjacent to the outlets of the first and second compartments or into a mixing chamber forming part of the container. However with this kind of arrangement steps may need to be taken to avoid contamination of the contents of the chambers. The container can also be designed to issue separate first and second components of compositions which are mixed substantially only when contacting the fabrics or even, the container can be designed to allow the first and second components to be mixed during the stream of the products to the fabrics. In a preferred embodiment, according to the process of the invention, the container is designed to mix the separate first and second components of compositions only when contacting the fabrics, thus the chlorine dioxide is generated in-situ.

This multi-compartment container can be a spray execution, or a bottle with two nozzles at the end.

In a preferred embodiment, wherein said multi-compartment container does not have a mixing outlet, the mixing step can be performed in a dosing cup wherein the two components are premixed before the application on the stain. This container has the purpose to facilitate the deposition/mixing/scrubbing of the two different components on the stain.

Containers suitable for use in this aspect of the invention are well known. According to the invention, the multi-compartments container has the form of a multi-compartments bottle or spray. Examples include two-compartments trigger sprays having a mechanical pumping action and side-by-side twin squeeze bottle chambers having simple narrowed nozzle outlets. In an even more preferred embodiment, the multi-compartment container herein is a multi-compartment bottle or spray.

The first and second components of compositions can also be separated in two different phases in the same composition, the mixing of the two components is achieved by shaking such a composition.

In a preferred way of obtaining the composition, according to the invention, comprising chlorine dioxide, is provided by a system which comprises two components wherein the first component comprises a chlorine dioxide precursor and the second component comprises a chlorine dioxide activator, which, on admixture with the first component, reacts with the precursor to form chlorine dioxide.

The chlorine dioxide precursors are compounds which result in the formation of the chlorite ion (ClO²⁻) or of the chlorate ion (ClO³⁻). The chlorine dioxide precursors can be chosen from the group consisting of sodium chlorite (NaClO₂), sodium chlorate (NaClO₃), potassium chlorite (KClO₂), potassium chlorate (KClO₃), lithium chlorite (LiClO₂), lithium chlorate (LiClO₃), chlorous acid (HClO₂) or chloric acid (HClO₃).

Preferably, the chlorine dioxide precursor is sodium chlorite or sodium chlorate. More preferably the chlorine dioxide precursor is the sodium chlorite.

In a preferred embodiment, the chlorine dioxide activator is an acid source, such as for example citric acid or oxalic acid. In a more preferred embodiment the chlorine dioxide activator is citric acid.

In a preferred embodiment, the chlorine dioxide is generated by mixing sodium chlorite (NaClO₂) with a source of acidity or an acid. Therefore, in a preferred embodiment, the chlorine dioxide precursor is sodium chlorite and the activator is a source of acidity.

In another preferred embodiment, the chlorine dioxide is generated by the oxidation of sodium chlorite (NaClO₂) with sodium persulfate (Na₂S₂O₈). Therefore, in a preferred embodiment, the chlorine dioxide precursor is sodium chlorite.

In another preferred embodiment, the chlorine dioxide is generated by a mix of sodium chlorate (NaClO₃) with hydrogen peroxide (H₂O₂) and with an acidic source such as sulphuric acid (H₂SO₄) for example.

Therefore, in another preferred embodiment, the chlorine dioxide is generated by a mix of chloric acids (HClO₃) with oxalic acid (H₂C₂O₄).

Thus, more particularly, the present invention further encompasses a process of treating a fabric by applying onto said fabric a composition comprising chlorine dioxide, wherein said composition is packaged in a multi-compartment container having at least two compartments, wherein a first compartment comprises a composition containing a chlorine dioxide precursor and wherein a second compartment comprises a composition containing a chlorine dioxide activator.

In a preferred embodiment, the compositions in the first compartment comprise a chlorine dioxide precursor. In a more preferred embodiment, the chlorine dioxide precursor of the composition in the first compartment, is sodium chlorite. The chlorine dioxide precursor, in the first compartment, may be present, in the composition, from 0.005% to 20% by weight of the total composition, preferably from 0.01% to 5% by weight and more preferably from 1% to 3%.

The compositions comprise peroxygen bleach. More preferably, the peroxygen bleach is in the second composition. Hydrogen peroxide is most preferred to be used in the compositions.

The two compositions are mixed upon use to form the bleaching composition herein. Upon mixing of the composition, the chlorine dioxide precursor, such as, for example sodium chlorite (NaClO₂) or sodium chlorate (NaClO₃), is in an acidic composition, and releases the chlorine dioxide. The acidic composition is present in an excess amount in order to acidify the first composition.

Preferably, the composition comprising a chlorine dioxide precursor, is formulated in the neutral or in the alkaline pH range. It is within this neutral to alkaline pH range that the composition has its optimum chemical stability and performance. Accordingly, the composition has preferably a pH equal or above 7. The composition in the second compartment, comprising a chlorine dioxide activator, is preferably formulated to be acidic, i.e. has a pH below 7. More preferably, the composition is formulated to have a pH comprise between 1 and 5. In a more preferred embodiment, the composition is formulated to have a pH comprise between 3 and 5.

In a preferred embodiment, the composition comprising a chlorine dioxide precursor is an alkaline or neutral composition and the composition comprising a chlorine dioxide activator is an acidic composition. Wherein upon mixing of the alkaline composition and the acidic composition the resulting admixing composition is acidic and generates chlorine dioxide.

Accordingly, the compositions herein may further comprise an acid or a base to adjust the pH as appropriate. Preferred acids herein are organic or inorganic acids or mixtures thereof. Preferred organic acids are acetic acid, succinic acid, citric acid or a mixture thereof. Preferred inorganic acids are sulphuric acid, phosphoric acid or a mixture thereof. A particularly preferred acid to be used herein is an organic acid and most preferred is citric acid. Typical levels of such acids, when present, are of from 0.01% to 10%, preferably from 0.1% to 5% and more preferably from 1% to 3% by weight of the total composition. The bases to be used herein can be organic or inorganic bases. Suitable bases for use herein are the caustic alkalis, such as sodium hydroxide, sodium carbonate, potassium hydroxide and/or lithium hydroxide, and/or the alkali metal oxides such as sodium and/or potassium oxide or mixtures thereof. Other suitable bases, include ammonia, ammonium carbonate and hydrogen carbonate. A preferred base is sodium carbonate. Typical levels of such bases are of from 0.001% to 1.0%, preferably from 0.05% to 5% and more preferably from 0.01% to 1% by weight of the total composition.

The compositions herein, may further comprise a variety of other optional ingredients such as chelating agents, builders, surfactants, stabilisers, bleach activators, soil suspenders, soil suspending polyamine polymers, polymeric soil release agents, foam reducing systems, radical scavengers, catalysts, dye transfer agents, brighteners, perfumes, hydrotropes, pigments and dyes.

Surfactants:

The compositions may further comprise a surfactant including nonionic surfactants, zwiterrionic surfactants, anionic surfactants, cationic surfactants and/or amphoteric surfactants. Highly preferred compositions comprise a nonionic surfactant or a zwiterrionic betaine surfactant or a mixture thereof.

Typically, the compositions may comprise from 0.01% to 30%, preferably from 0.1% to 25% and more preferably from 0.5% to 20% by weight of the total composition of a surfactant.

Suitable nonionic surfactants include alkoxylated nonionic surfactants. Preferred alkoxylated nonionic surfactants herein are ethoxylated nonionic surfactants according to the formula RO—(C₂H₄O)ₙH, wherein R is a C₆ to C₂₂ alkyl chain or a C₆ to C₂₈ alkyl benzene chain, and wherein n is from 0 to 20, preferably from 1 to 15 and, more preferably from 2 to 15 and most preferably from 2 to 12. The preferred R chains for use herein are the C₈ to C₂₂ alkyl chains. Propoxylated nonionic surfactants and ethoxy/propoxylated ones may also be used herein instead of the ethoxylated nonionic surfactants as defined herein above or together with said surfactants. Preferred ethoxylated nonionic surfactants are according to the formula above and have an HLB (hydrophilic-lipophilic balance) below 16, preferably below 15, and more preferably below 14. Those ethoxylated nonionic surfactants have been found to provide good grease cutting properties.

Accordingly suitable ethoxylated nonionic surfactants for use herein are Dobanol® 91-2.5 (HLB=8.1; R is a mixture of C9 and C₁₁ alkyl chains, n is 2.5), or Lutensol® TO3 (HLB=8; R is a C₁₃ alkyl chains, n is 3), or Lutensol® A03 (HLB=8; R is a mixture of C₁₃ and C₁₅ alkyl chains, n is 3), or Tergitol® 25L3 (HLB=7.7; R is in the range of C₁₂ to C₁₅ alkyl chain length n is 3), or Dobanol® 23-3 (HLB=8.1; R is a mixture of C₁₂ and C₁₃ alkyl chains, n is 3), or Dobanol® 23-2 (HLB=6.2; R is a mixture of C₁₂ and C₁₃ alkyl chains, n is 2), or Dobanol® 45-7 (HLB=11.6; R is a mixture of C₁₄ and C₁₅ alkyl chains, n is 7) Dobanol® 23-6.5 (HLB=11.9; R is a mixture of C₁₂ and C₁₃ alkyl chains, n is 6.5), or Dobanol® 25-7 (HLB=12; R is a mixture of C₁₂ and C₁₅ alkyl chains, n is 7), or Dobanol® 91-5 (HLB=11.6; R is a mixture of C₉ and C₁₁ alkyl chains, n is 5), or Dobanol® 91-6 (HLB=12.5; R is a mixture of C₉ and C₁₁ alkyl chains, n is 6), or Dobanol® 91-8 (HLB=13.7 ; R is a mixture of C₉ and C₁₁ alkyl chains, n is 8), Dobanol® 91-10 (HLB=14.2; R is a mixture of C₉ to C₁₁ alkyl chains, n is 10), Dobanol® 91-12 (HLB=14.5; R is a mixture of C₉ to C₁₁ alkyl chains, n is 12), or mixtures thereof. Preferred herein are Dobanol® 91-2.5, or Lutensol® TO3, or Lutensol® AO3, or Tergitol® 25L3, or Dobanol® 23-3, or Dobanol® 23-2, or Dobanol® 45-7, Dobanol® 91-8, or Dobanol® 91-10, or Dobanol® 91-12, or mixtures thereof. These Dobanol® surfactants are commercially available from SHELL. These Lutensol® surfactants are commercially available from BASF and these Tergitol® surfactants are commercially available from UNION CARBIDE.

Suitable chemical processes for preparing the alkoxylated nonionic surfactants for use herein include condensation of corresponding alcohols with alkylene oxide, in the desired proportions. Such processes are well known to the man skilled in the art and have been extensively described in the art.

The compositions herein may desirably comprise one of those ethoxylated nonionic surfactants or a mixture of those ethoxylated nonionic surfactants having different HLBs (hydrophilic-lipophilic balance). In a preferred embodiment the compositions herein comprise an ethoxylated nonionic surfactant according to the above formula and having an HLB up to 10 (i.e., a so called hydrophobic ethoxylated nonionic surfactant), preferably below 10, more preferably below 9, and an ethoxylated nonionic surfactant according to the above formula and having an HLB above 10 to 16 (i.e., a so called hydrophilic ethoxylated nonionic surfactant), preferably from 11 to 14. Indeed, in this preferred embodiment the compositions typically comprise from 0.01% to 15% by weight of the total composition of said hydrophobic ethoxylated nonionic surfactant, preferably from 0.5% to 10% and from 0.01% to 15% by weight of said hydrophilic ethoxylated nonionic surfactant, preferably from 0.5% to 10%. Such mixtures of ethoxylated nonionic surfactants with different HLBs may be desired as they allow optimum grease cleaning removal performance on a broader range of greasy soils having different hydrophobic/hydrophilic characters.

Other suitable nonionic surfactants to be used herein include polyhydroxy fatty acid amide surfactants, or mixtures thereof, according to the formula:

R²—C(O)—N(R¹)-Z.

wherein R¹ is H, or C₁-C₄ alkyl, C₁-C₄ hydrocarbyl, 2-hydroxy ethyl, 2-hydroxy propyl or a mixture thereof, R² is C₅-C₃₁ hydrocarbyl, and Z is a polyhydroxyhydrocarbyl having a linear hydrocarbyl chain with at least 3 hydroxyls directly connected to the chain, or an alkoxylated derivative thereof.

Preferably, R¹ is C₁-C₄ alkyl, more preferably C₁ or C₂ alkyl and most preferably methyl, R² is a straight chain C₇-C₁₉ alkyl or alkenyl, preferably a straight chain C₉-C₁₈ alkyl or alkenyl, more preferably a straight chain C₁₁-C₁₈ alkyl or alkenyl, and most preferably a straight chain C₁₁-C₁₄ alkyl or alkenyl, or mixtures thereof. Z preferably will be derived from a reducing sugar in a reductive amination reaction; more preferably Z is a glycityl. Suitable reducing sugars include glucose, fructose, maltose, lactose, galactose, mannose and xylose. As raw materials, high dextrose corn syrup, high fructose corn syrup, and high maltose corn syrup can be utilized as well as the individual sugars listed above. These corn syrups may yield a mix of sugar components for Z. It should be understood that it is by no means intended to exclude other suitable raw materials. Z preferably will be selected from the group consisting of —CH₂—(CHOH)ₙ—CH₂OH, —CH(CH₂OH)—(CHOH)ₙ₋₁—CH₂OH, —CH₂—(CHOH)₂—(CHOR′)(CHOH)—CH₂OH, where n is an integer from 3 to 5, inclusive, and R′ is H or a cyclic or aliphatic monosaccharide, and alkoxylated derivatives thereof. Most preferred are glycityls wherein n is 4, particularly CH₂—(CHOH)₄—CH₂OH.

In formula R²—C(O)—N(R¹)—Z, R¹ can be, for example, N-methyl, N-ethyl, N-propyl, N-isopropyl, N-butyl, N-2-hydroxy ethyl, or N-2-hydroxy propyl. R²—C(O)—N< can be, for example, cocamide, stearamide, oleamide, lauramide, myristamide, capricamide, palmitamide, tallowamide and the like. Z can be 1-deoxyglucityl, 2-deoxyfructityl, 1-deoxymaltityl, 1-deoxylactityl, 1-deoxygalactityl, 1-deoxymannityl, 1-deoxymaltotriotityl and the like.

Suitable polyhydroxy fatty acid amide surfactants to be used herein may be commercially available under the trade name HOE® from Hoechst.

Methods for making polyhydroxy fatty acid amide surfactants are known in the art. In general, they can be made by reacting an alkyl amine with a reducing sugar in a reductive amination reaction to form a corresponding N-alkyl polyhydroxyamine, and then reacting the N-alkyl polyhydroxyamine with a fatty aliphatic ester or triglyceride in a condensation/amidation step to form the N-alkyl, N-polyhydroxy fatty acid amide product. Processes for making compositions containing polyhydroxy fatty acid amides are disclosed for example in GB patent specification 809,060, published Feb. 18, 1959, by Thomas Hedley & Co., Ltd., U.S. Pat. No. 2,965,576, issued Dec. 20, 1960 to E. R. Wilson, U.S. Pat. No. 2,703,798, Anthony M. Schwartz, issued Mar. 8, 1955, U.S. Pat. No. 1,985,424, issued Dec. 25, 1934 to Piggott and WO92/06070, each of which is incorporated herein by reference.

Suitable zwitterionic betaine surfactants for use herein contain both a cationic hydrophilic group, i.e., a quaternary ammonium group, and anionic hydrophilic group on the same molecule at a relatively wide range of pH's. The typical anionic hydrophilic groups are carboxylates and sulphonates, although other groups like sulfates, phosphonates, and the like can be used. A generic formula for the zwitterionic betaine surfactant to be used herein is

R₁—N⁺(R₂)(R₃)R₄X⁻

wherein R₁ is a hydrophobic group; R₂ is hydrogen, C₁-C₆ alkyl, hydroxy alkyl or other substituted C₁-C₆ alkyl group; R₃ is C₁-C₆ alkyl, hydroxy alkyl or other substituted C₁-C₆ alkyl group which can also be joined to R₂ to form ring structures with the N, or a C₁-C₆ sulphonate group; R₄ is a moiety joining the cationic nitrogen atom to the hydrophilic group and is typically an alkylene, hydroxy alkylene, or polyalkoxy group containing from 1 to 10 carbon atoms; and X is the hydrophilic group, which is a carboxylate or sulphonate group.

Preferred hydrophobic groups R₁ are aliphatic or aromatic, saturated or unsaturated, substituted or unsubstituted hydrocarbon chains that can contain linking groups such as amido groups, ester groups. More preferred R₁ is an alkyl group containing from 1 to 24 carbon atoms, preferably from 8 to 18, and more preferably from 10 to 16. These simple alkyl groups are preferred for cost and stability reasons. However, the hydrophobic group R₁ can also be an amido radical of the formula Rₐ—C(O)—NH—(C(R_{b})₂)ₘ, wherein Rₐ is an aliphatic or aromatic, saturated or unsaturated, substituted or unsubstituted hydrocarbon chain, preferably an alkyl group containing from 8 up to 20 carbon atoms, preferably up to 18, more preferably up to 16, R_{b} is selected from the group consisting of hydrogen and hydroxy groups, and m is from 1 to 4, preferably from 2 to 3, more preferably 3, with no more than one hydroxy group in any (C(R_{b})₂) moiety.

Preferred R₂ is hydrogen, or a C₁-C₃ alkyl and more preferably methyl. Preferred R₃ is C₁-C₄ sulphonate group, or a C₁-C₃ alkyl and more preferably methyl. Preferred R₄ is (CH2)ₙ wherein n is an integer from 1 to 10, preferably from 1 to 6, more preferably is from 1 to 3.

Some common examples of betaine/sulphobetaine are described in U.S. Pat. Nos. 2,082,275, 2,702,279 and 2,255,082.

Examples of particularly suitable alkyldimethyl betaines include coconut-dimethyl betaine, lauryl dimethyl betaine, decyl dimethyl betaine, 2-(N-decyl-N,N-dimethyl-ammonia)acetate, 2-(N-coco N,N-dimethylammonio) acetate, myristyl dimethyl betaine, palmityl dimethyl betaine, cetyl dimethyl betaine, stearyl dimethyl betaine. For example Coconut dimethyl betaine is commercially available from Seppic under the trade name of Amonyl 265®. Lauryl betaine is commercially available from Albright & Wilson under the trade name Empigen BB/L®.

Examples of amidobetaines include cocoamidoethylbetaine, cocoamidopropyl betaine or C₁₀-C₁₄ fatty acylamidopropylene(hydropropylene)sulfobetaine. For example C₁₀-C₁₄ fatty acylamidopropylene(hydropropylene)sulfobetaine is commercially available from Sherex Company under the trade name “Varion CAS® sulfobetaine”.

A further example of betaine is Lauryl-immino-dipropionate commercially available from Rhone-Poulenc under the trade name Mirataine H₂C-HA®.

Suitable anionic surfactants to be used in the compositions herein include water-soluble salts or acids of the formula ROSO₃M wherein R preferably is a C₁₀-C₂₄ hydrocarbyl, preferably an alkyl or hydroxyalkyl having a C₁₀-C₂₀ alkyl component, more preferably a C₁₂-C₁₈ alkyl or hydroxyalkyl, and M is H or a cation, e.g., an alkali metal cation (e.g., sodium, potassium, lithium), or ammonium or substituted ammonium (e.g., methyl-, dimethyl-, and trimethyl ammonium cations and quaternary ammonium cations, such as tetramethyl-ammonium and dimethyl piperdinium cations and quaternary ammonium cations derived from alkylamines such as ethylamine, diethylamine, triethylamine, and mixtures thereof, and the like). Typically, alkyl chains of C₁₂-₁₆ are preferred for lower wash temperatures (e.g., below about 50° C.) and C₁₆₋₁₈ alkyl chains are preferred for higher wash temperatures (e.g., above about 50° C.).

Other suitable anionic surfactants for use herein are water-soluble salts or acids of the formula RO(A)ₘSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy or propoxy unit, m is greater than zero, typically between 0.5 and 6, more preferably between 0.5 and 3, and M is H or a cation which can be, for example, a metal cation (e.g., sodium, potassium, lithium, calcium, magnesium, etc.), ammonium or substituted-ammonium cation. Alkyl ethoxylated sulfates as well as alkyl propoxylated sulfates are contemplated herein. Specific examples of substituted ammonium cations include methyl-, dimethyl-, trimethyl-ammonium and quaternary ammonium cations, such as tetramethyl-ammonium, dimethyl piperdinium and cations derived from alkanolamines such as ethylamine, diethylamine, triethylamine, mixtures thereof, and the like. Exemplary surfactants are C₁₂-C₁₈ alkyl polyethoxylate (1.0) sulfate (C₁₂-C₁₈E(1.0)SM), C₁₂-C₁₈ alkyl polyethoxylate (2.25) sulfate (C₁₂-C₁₈E(2.25)SM), C₁₂-C₁₈ alkyl polyethoxylate (3.0) sulfate (C₁₂-C₁₈E(3.0)SM), and C₁₂-C₁₈ alkyl polyethoxylate (4.0) sulfate (C₁₂-C₁₈E(4.0)SM), wherein M is conveniently selected from sodium and potassium.

Other anionic surfactants useful for detersive purposes can also be used herein. These can include salts (including, for example, sodium, potassium, ammonium, and substituted ammonium salts such as mono-, di- and triethanolamine salts) of soap, C₉-C₂₀ linear alkylbenzenesulphonates, C₈-C₂₂ primary or secondary alkanesulphonates, C₈-C₂₄ olefinsulphonates, sulphonated polycarboxylic acids prepared by sulphonation of the pyrolyzed product of alkaline earth metal citrates, e.g., as described in British patent specification No. 1,082,179, C₈-C₂₄ alkylpolyglycolethersulfates (containing up to 10 moles of ethylene oxide); alkyl ester sulphonates such as C₁₄₋₁₆ methyl ester sulphonates; acyl glycerol sulphonates, fatty oleyl glycerol sulfates, alkyl phenol ethylene oxide ether sulfates, paraffin sulphonates, alkyl phosphates, isethionates such as the acyl isethionates, N-acyl taurates, alkyl succinamates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), sulfates of alkylpolysaccharides such as the sulfates of alkylpolyglucoside (the nonionic nonsulfated compounds being described below), branched primary alkyl sulfates, alkyl polyethoxy carboxylates such as those of the formula RO(CH₂CH₂O)ₖCH₂COO-M⁺ wherein R is a C₈-C₂₂ alkyl, k is an integer from 0 to 10, and M is a soluble salt-forming cation. Resin acids and hydrogenated resin acids are also suitable, such as rosin, hydrogenated rosin, and resin acids and hydrogenated resin acids present in or derived from tall oil. Further examples are given in “Surface Active Agents and Detergents” (Vol. I and II by Schwartz, Perry and Berch). A variety of such surfactants are also generally disclosed in U.S. Pat. No. 3,929,678, issued Dec. 30, 1975, to Laughlin, et al. at Column 23, line 58 through Column 29, line 23 (herein incorporated by reference).

Other suitable anionic surfactants to be used herein also include acyl sarcosinate or mixtures thereof, in its acid and/or salt form, preferably long chain acyl sarcosinates having the following formula:

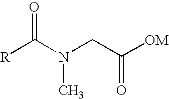

wherein M is hydrogen or a cationic moiety and wherein R is an alkyl group of from 11 to 15 carbon atoms, preferably of from 11 to 13 carbon atoms. Preferred M are hydrogen and alkali metal salts, especially sodium and potassium. Said acyl sarcosinate surfactants are derived from natural fatty acids and the amino-acid sarcosine (N-methyl glycine). They are suitable to be used as aqueous solution of their salt or in their acidic form as powder. Being derivatives of natural fatty acids, said acyl sarcosinates are rapidly and completely biodegradable and have good skin compatibility.

Accordingly, suitable long chain acyl sarcosinates to be used herein include C₁₂ acyl sarcosinate (i.e., an acyl sarcosinate according to the above formula wherein M is hydrogen and R is an alkyl group of 11 carbon atoms) and C₁₄ acyl sarcosinate (i.e., an acyl sarcosinate according to the above formula wherein M is hydrogen and R is an alkyl group of 13 carbon atoms). C₁₂ acyl sarcosinate is commercially available, for example, as Hamposyl L-30® supplied by Hampshire. C₁₄ acyl sarcosinate is commercially available, for example, as Hamposyl M-30® supplied by Hampshire.

Suitable amphoteric surfactants to be used herein include amine oxides having the following formula R₁R₂R₃NO wherein each of R₁, R₂ and R₃ is independently a saturated substituted or unsubstituted, linear or branched hydrocarbon chains of from 1 to 30 carbon atoms. Preferred amine oxide surfactants to be used are amine oxides having the following formula R₁R₂R₃NO wherein R₁ is an hydrocarbon chain comprising from 1 to 30 carbon atoms, preferably from 6 to 20, more preferably from 8 to 16, most preferably from 8 to 12, and wherein R₂ and R₃ are independently substituted or unsubstituted, linear or branched hydrocarbon chains comprising from 1 to 4 carbon atoms, preferably from 1 to 3 carbon atoms, and more preferably are methyl groups. R1 may be a saturated substituted or unsubstituted linear or branched hydrocarbon chain. Suitable amine oxides for use herein are for instance natural blend C₈-C₁₀ amine oxides as well as C₁₂-C₁₆ amine oxides commercially available from Hoechst.

Chelating Agents:

The compositions may comprise a chelating agent as a preferred optional ingredient. Suitable chelating agents may be any of those known to those skilled in the art such as the ones selected from the group comprising phosphonate chelating agents, amino carboxylate chelating agents, other carboxylate chelating agents, polyfunctionally-substituted aromatic chelating agents, ethylenediamine N,N′-disuccinic acids, or mixtures thereof.

A chelating agent may be desired in the compositions as it allows to increase the ionic strength of the compositions herein and thus their stain removal and bleaching performance on various surfaces. The presence of chelating agents may also contribute to reduce the tensile strength loss of fabrics and/or color damage, especially in a laundry pretreatment application.

Suitable phosphonate chelating agents to be used herein may include alkali metal ethane 1-hydroxy diphosphonates (HEDP), alkylene poly (alkylene phosphonate), as well as amino phosphonate compounds, including amino aminotri(methylene phosphonic acid) (ATMP), nitrilo trimethylene phosphonates (NTP), ethylene diamine tetra methylene phosphonates, and diethylene triamine penta methylene phosphonates (DTPMP). The phosphonate compounds may be present either in their acid form or as salts of different cations on some or all of their acid functionalities. Preferred phosphonate chelating agents to be used herein are diethylene triamine penta methylene phosphonate (DTPMP) and ethane 1-hydroxy diphosphonate (HEDP). Such phosphonate chelating agents are commercially available from Monsanto under the trade name DEQUEST®.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy -3,5-disulfobenzene. A preferred biodegradable chelating agent for use herein is ethylene diamine N,N′-disuccinic acid, or alkali metal, or alkaline earth, ammonium or substitutes ammonium salts thereof or mixtures thereof. Ethylenediamine N,N′-disuccinic acids, especially the (S,S) isomer, have been extensively described in U.S. Pat. No. 4, 704, 233, Nov. 3, 1987, to Hartman and Perkins. Ethylenediamine N,N′-disuccinic acid is, for instance, commercially available under the tradename ssEDDS® from Palmer Research Laboratories.

Suitable amino carboxylates to be used herein include ethylene diamine tetra acetates, diethylene triamine pentaacetates, diethylene triamine pentaacetate (DTPA),N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine di-acetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS® and methyl glycine di-acetic acid (MGDA).

Further carboxylate chelating agents to be used herein include salicylic acid, aspartic acid, glutamic acid, glycine, malonic acid or mixtures thereof.

Another chelating agent for use herein is of the formula:

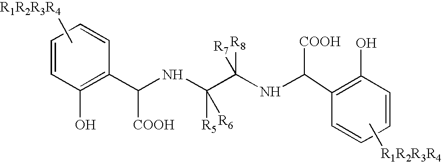

wherein R₁, R₂, R₃, and R₄ are independently selected from the group consisting of —H, alkyl, alkoxy, aryl, aryloxy, —Cl, —Br, —NO₂, —C(O)R′, and —SO₂R″; wherein R′ is selected from the group consisting of —H, —OH, alkyl, alkoxy, aryl, and aryloxy; R″ is selected from the group consisting of alkyl, alkoxy, aryl, and aryloxy; and R₅, R₆, R₇, and R₈ are independently selected from the group consisting of —H and alkyl.

Particularly preferred chelating agents to be used herein are amino aminotri(methylene phosphonic acid), di-ethylene-triamino-pentaacetic acid, diethylene triamine penta methylene phosphonate, 1-hydroxy ethane diphosphonate, ethylenediamine N,N′-disuccinic acid, and mixtures thereof.

Typically, the compositions may comprise up to 5%, preferably from 0.01% to 1.5% by weight and more preferably from 0.01% to 0.5% by weight of the total composition of a chelating agent.

Radical Scavenger:

The compositions may comprise a radical scavenger or a mixture thereof. Suitable radical scavengers for use herein include the well-known substituted mono and dihydroxy benzenes and their analogs, alkyl and aryl carboxylates and mixtures thereof. Preferred such radical scavengers for use herein include di-tert-butyl hydroxy toluene (BHT), hydroquinone, di-tert-butyl hydroquinone, mono-tert-butyl hydroquinone, tert-butyl-hydroxy anysole, benzoic acid, toluic acid, catechol, t-butyl catechol, benzylamine, 1,1,3-tris(2-methyl-4-hydroxy-5-t-butylphenyl)butane, n-propyl-gallate or mixtures thereof and highly preferred is di-tert-butyl hydroxy toluene. Such radical scavengers like N-propyl-gallate may be commercially available from Nipa Laboratories under the trade name Nipanox S1®. Radical scavengers when used, are typically present herein in amounts ranging from up to 10% and preferably from 0.001% to 0.5% by weight of the total composition.

The presence of radical scavengers may contribute to reduce tensile strength loss of fabrics and/or color damage when the compositions are used in any laundry application, especially in a laundry pretreatment application.

Antioxidant:

The compositions may further comprise an antioxidant or mixtures thereof. Typically, the compositions herein may comprise up to 10%, preferably from 0.002% to 5%, more preferably from 0.005% to 2%, and most preferably from 0.01% to 1% by weight of the total composition of an antioxidant.

Suitable antioxidants to be used herein include organic acids like citric acid, ascorbic acid, tartaric acid, adipic acid and sorbic acid, or amines like lecithin, or aminoacids like glutamine, methionine and cysteine, or esters like ascorbil palmitate, ascorbil stearate and triethylcitrate, or mixtures thereof. Preferred antioxidants for use herein are citric acid, ascorbic acid, ascorbil palmitate, lecithin or mixtures thereof.

Builder:

The compositions may further comprise one or more builders and/or a modified polycarboxylate co-builder.

Suitable builders are selected from the group consisting of : organic acids and salts thereof; polycarboxylates; and mixtures thereof. Typically said builders have a calcium chelating constant (pKCa) of at least 3. Herein the pKCa the value of a builder or a mixture thereof is measured using a 0.1M NH₄Cl—NH₄OH buffer (pH 10 at 25° C.) and a 0.1% solution of said builder or mixture thereof with a standard calcium ion electrode.

Examples of builders are organic acids like citric acid, lactic acid, tartaric acid, oxalic acid, malic acid, monosuccinic acid, disuccinic acid, oxydisuccinic acid, carboxymethyl oxysuccinic acid, diglycolic acid, carboxymethyl tartronate, ditartronate and other organic acid or mixtures thereof.

Suitable salts of organic acids include alkaline, preferably sodium or potassium, alkaline earth metal, ammonium or alkanolamine salts.

Such organic acids and the salts thereof are commercially available from Jungbunzlaur, Haarman & Reimen, Sigma-Aldrich or Fluka.

Other suitable builders include a wide variety of polycarboxylate compounds. As used herein, “polycarboxylate” refers to compounds having a plurality of carboxylate groups, preferably at least 3 carboxylates. Polycarboxylate builder can generally be added to the composition in acid form, but can also be added in the form of a neutralized salt or “overbased”. When utilized in salt form, alkali metals, such as sodium, potassium, and lithium, or alkanolammonium salts are preferred.

Useful polycarboxylates include homopolymers of acrylic acid and copolymers of acrylic acid and maleic acid.

Other useful polycarboxylate builders include the ether hydroxypolycarboxylates, copolymers of maleic anhydride with ethylene or vinyl methyl ether, 1,3,5-trihydroxy benzene-2,4,6-trisulfonic acid, and carboxymethyloxysuccinic acid, the various alkali metal, ammonium and substituted ammonium salts of polyacetic acids such as nitrilotriacetic acid, as well as polycarboxylates such as mellitic acid, succinic acid, oxydisuccinic acid, polymaleic acid, benzene 1,3,5-tricarboxylic acid, carboxymethyloxysuccinic acid, and soluble salts thereof.

Suitable polycarboxylates are commercially available from Rohm & Haas under the trade name Norasol® or Acusol®.

Preferred builders herein are selected from the group consisting of : citric acid; tartaric acid; tartrate monosuccinate; tartrate disuccinate; lactic acid; oxalic acid; and malic acid; and mixtures thereof. Even more preferred builders herein are selected from the group consisting of: citric acid; tartaric acid; tartrate monosuccinate; tartrate disuccinate; and malic acid; and mixtures thereof. The most preferred builders herein are selected from the group consisting of: citric acid; tartaric acid; tartrate monosuccinate; and tartrate disuccinate; and mixtures thereof.

Typically the bleaching compositions herein may comprise up to 40%, preferably from 0.01% to 25%, more preferably from 0.1% to 15%, and most preferably from 0.5% to 10% by weight of the total composition of said builder.

The compositions may further comprise a modified polycarboxylate co-builder. The term “polycarboxylate” refers to compounds having a plurality of carboxylate groups, preferably at least 3 carboxylates.

By “modified polycarboxylate” it is meant herein that at least at one end of the polycarboxylate compound, i.e., the polycarboxylate chain, said compound is modified by a functional group, e.g., a phosphono group.

Preferred modified polycarboxylate co-builders are polycarboxylates with phosphono end groups.

By “phosphono end group” it is meant herein a phosphono functional group according to the formula:

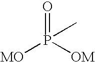

wherein each M is independently H or a cation, preferably both M are H.

Examples of suitable polycarboxylates with phosphono end groups are copolymers of acrylic acid and maleic acid having a phosphono end group and homopolymers of acrylic acid having a phosphono end group.

A preferred modified polycarboxylate is a copolymer of acrylic acid and maleic acid with a phosphonic/phosphono end group according to the general formula:

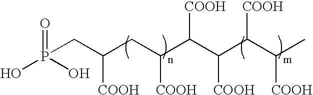

having an average molecular weight of from 1000 to 100000, preferably an average molecular weight of from 1000 to 20000, more preferably an average molecular weight of from 1000 to 10000, and most preferably an average molecular weight of from 1500 to 5000; wherein n is from 10 mol % to 90 mol %, preferably 80 mol % and m is from 10 mol % to 90 mol %, preferably 20 mol %.

Accordingly, an example of a suitable modified polycarboxylate is a copolymer of acrylic acid and maleic acid (80/20) with a phosphonic/phosphono end group according to the formula:

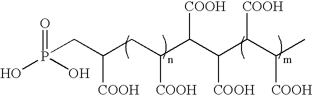

wherein n is 80 mol % and m is 20 mol %; having an average molecular weight of 2000.

Such modified polycarboxylate are available from Rohm & Haas under the trade name Acusol 425®, Acusol 420® or Acusol 470®.

Typically the bleaching compositions herein may comprise up to 40%, preferably from 0.01% to 25%, more preferably from 0.1% to 15%, and most preferably from 0.5% to 5% by weight of the total composition of said modified polycarboxylate co-builder.

Anti-Resoiling Polymers:

The compositions may comprise as a highly preferred, but optional ingredient an anti-resoiling polymer.

Suitable anti-resoiling polymers include soil suspending polyamine polymers. Any soil suspending polyamine polymer known to those skilled in the art may also be used herein. Particularly suitable polyamine polymers for use herein are alkoxylated polyamines. Such materials can conveniently be represented as molecules of the empirical structures with repeating units:

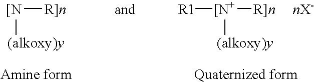

wherein R is a hydrocarbyl group, usually of 2-6 carbon atoms; R₁ may be a C₁-C₂₀ hydrocarbon; the alkoxy groups are ethoxy, propoxy, and the like, and y is from 2 to 30, most preferably from 7 to 20; n is an integer of at least 2, preferably from 2 to 40, most preferably from 2 to 5; and X⁻ is an anion such as halide or methylsulfate, resulting from the quaternization reaction.

Highly preferred polyamines for use herein are the so-called ethoxylated polyethylene amines, i.e., the polymerized reaction product of ethylene oxide with ethyleneimine, having the general formula:

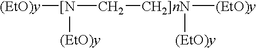

wherein y is from 2 to 50, preferably from 5 to 30, and n is from 1 to 40, preferably from 2 to 40. Particularly preferred for use herein is an ethoxylated polyethylene amine, in particular an ethoxylated polyethylene amine wherein n=2 and y=20, and an ethoxylated polyethylene amine wherein n=40 and y=7.

Suitable ethoxylated polyethylene amines are commercially available from Nippon Shokubai CO., LTD or from BASF.

Furthermore, highly preferred polyamines for use herein are the so-called ethoxylated polyethylene quaternized amines having the general formula:

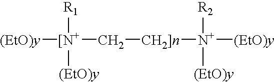

wherein y is from 2 to 50, preferably from 5 to 30, and n is from 1 to 40, preferably from 2 to 40 and R1 and R2 are independently a C₁-C₂₀ hydrocarbon. Particularly preferred for use herein is an ethoxylated polyethylene amine, in particular an ethoxylated polyethylene amine wherein n=2 and y=20, and an ethoxylated polyethylene amine wherein n=40 and y=7.

Particularly preferred herein is 24-Ethoxylated Hexamethylene Diamine Quaternized methyl chloride (EHDQ), commercially available from BASF.

The invention is further illustrated by the following examples. The following examples are meant to exemplify compositions used in process according to the present invention but are not necessarily used to limit or otherwise define the scope of the present invention.

### Examples of Compositions:

The compositions are made by combining the listed ingredients in the listed proportions (weight % unless otherwise specified).

| Composition | i |
|---|---|
| Carnebon 200 (1) | 84.600 |
| H₂O₂ | 2.000 |
| Marlipal 24.7 (2) | 2.500 |
| Neodol 23-1.1E (3) | 2.500 |
| KOH | 1.400 |
| HLAS (6) | 5.000 |
| HEDP (7) | 1.000 |
| Perfume | 0.130 |

| Composition | ii | iii |
|---|---|---|
| Marlipal 24-7 (2) | 3.19 | — |
| Hydrogen peroxide | 6.48 | — |
| NaClO₂ | 0.76 | 0.76 |
| H₂SO₄ | 0.003 | — |
| EHDQ (4) | 2.71 | — |
| Na₂-HEDP (7) | 0.15 | — |
| Citric acid | 1.90 | 1.90 |
| Sodium Xylen sulfonate | 0.42 | — |
| Perfume | 0.22 | — |

| | |
|---|---|
| Water and minors | up to 100% |

Compositions I-IX are packaged in a two compartments container wherein a first compartment comprises compositions A, comprising a chlorine dioxide precursor, and wherein a second compartment comprises compositions B, comprising a chlorine dioxide activator.

| | I | II | III |
|---|---|---|---|
| Composition A | | | |
| NaClO₂ | 0.800 | 0.800 | 0.800 |
| Hydrogen Peroxide | — | 2.000 | — |
| Marlipal 24.7 (2) | — | 2.460 | 2.460 |
| Neodol 23-1.1E (3) | — | 2.495 | 2.495 |
| KOH | — | 1.360 | 1.360 |
| HLAS (6) | — | 4.950 | 4.950 |
| HEDP (7) | — | 1.000 | 1.000 |
| Perfume | — | 0.130 | 0.130 |
| TMBA (5) | — | 0.030 | 0.030 |
| Water and minors | up to 100% | | |
| Compositions B | | | |
| Hydrogen Peroxide | 2.000 | — | 2.000 |
| Citric acid | 3.200 | 3.200 | 3.200 |
| Marlipal 24.7 (2) | 2.460 | — | 2.460 |
| Neodol 23-1.1E (3) | 2.495 | — | 2.495 |
| KOH | 1.360 | — | 1.360 |
| HLAS (6) | 4.950 | — | 4.950 |
| HEDP (7) | 1.000 | — | 1.000 |
| TMBA (5) | — | — | 0.030 |
| Perfume | 0.130 | — | 0.130 |
| Water and minors | up to 100% | | |
| | IV | V | VI |
| Composition A | | | |
| NaClO₂ | 0.800 | 2.000 | 2.000 |
| Hydrogen Peroxide | — | 2.000 | — |
| Marlipal 24.7 (2) | 2.500 | 2.500 | 2.500 |
| Neodol 23-1.1E (3) | 2.500 | 2.500 | 2.500 |
| HEDP (7) | — | 1.000 | 1.000 |
| EHDQ (4) | — | 2.000 | — |
| Na₂CO₃ | 0.100 | — | — |
| Perfume | — | 0.030 | 0.030 |
| Water and minors | up to 100% | | |
| Composition B | | | |
| Hydrogen Peroxide | 2.000 | — | 2.000 |
| Sodium persulfate | 6.000 | 6.000 | 6.000 |
| Marlipal 24.7 (2) | 2.500 | — | 2.500 |
| Neodol 23-1.1E (3) | 2.500 | — | 2.500 |
| HEDP (7) | 1.000 | — | 1.000 |
| TMBA (5) | 0.030 | — | 0.030 |
| EHDQ (4) | 2.000 | — | — |
| Water and minors | up to 100% | | |
| | VII | VIII | IX |
| Composition A | | | |
| NaClO₃ | 0.800 | 2.000 | 2.000 |
| Hydrogen Peroxide | — | 2.000 | — |
| Marlipal 24.7 9 (2) | 2.500 | 2.500 | 2.500 |
| Neodol 23-1.1E (3) | 2.500 | 2.500 | 2.500 |
| HEDP (7) | — | 1.000 | 1.000 |
| EHDQ (4) | — | 2.000 | — |
| Na₂CO₃ | 0.100 | — | — |
| Perfume | — | 0.030 | 0.030 |
| Water and minors | up to 100% | | |
| Composition B | | | |
| Hydrogen Peroxide | 2.000 | — | 2.000 |
| Sodium persulfate | 6.000 | 6.000 | 6.000 |
| Marlipal 24.7 | 2.500 | — | 2.500 |
| Neodol 23-1.1E | 2.500 | — | 2.500 |
| HEDP | 1.000 | — | 1.000 |
| TMBA (5) | 0.030 | — | 0.030 |
| EHDQ (4) | 2.000 | — | — |
| Water and minors | 2.500 | — | 2.500 |

| | |
|---|---|
| Sodium persulfate | up to 100% |

(1) Carnebon 200 (an aqueous composition of stabilized Chlorine Dioxide) is commercially available from International Dioxcide Inc.
(2) Marlipal 24.7 (C12–14 ethoxylated alcohol) is commercially available from Condea.
(3) Neodol 23-1.1E (C12–13 ethoxylated alcohol) is commercially available from Shell.
(4) EHDQ is Ethoxylated hexamethylene diamine quaternized.
(5) TMBA (3,4,5-Trimethoxy benzene sulfonic acid) is commercially available from Aldrich.
(6) HLAS is Linear Alkylbenzene Sulfonic acid
(7) HEDP is1-Hydroxyethyldiene 1,1 Diphosphonic acid

The above compositions i to iii are applied to the fabrics and are left in contact with fabrics during 10 minutes before said fabrics are washed.

The mixing of the composition A+composition B of compositions I to IX, are applied onto the fabrics with a multi-compartments spray and are left in contact with the fabrics during 10 minutes before said fabrics are washed.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process of treating a fabric with a composition, said composition comprising chlorine dioxide and a peroxygen bleach.

2. A process according to claim 1 wherein the composition comprises a liquid aqueous composition.

3. A process according to claim 1 wherein the composition comprises from 0.0001% to 10% by weight of the total composition of chlorine dioxide.

4. A process according to claim 1 wherein the composition comprises from 0.001% to 2% by weight of the total composition of chlorine dioxide.

5. A process according to claim 1 wherein the composition comprises from 0.01% to 0.5% by weight of the total composition of chlorine dioxide.

6. A process according to claim 1 wherein the peroxygen bleach comprises hydrogen peroxide or a water soluble source thereof.

7. A process according to claim 1 wherein said composition comprises from 0.01% to 20% by weight of the total composition of said peroxygen bleach or mixtures thereof.

8. A process according to claim 1 wherein said composition comprises from 0.1% to 10% by weight of the total composition of said peroxygen bleach or mixtures thereof.

9. A process according to claim 1 wherein said composition comprises from 1% to 7% by weight of the total composition of said peroxygen bleach or mixtures thereof.

10. A process according to claim 1 wherein said composition comprises a surfactant and/or comprises a polymer.

11. A process according to claim 1 for pretreating fabrics which comprises the steps of applying said composition in its neat form onto said fabric and allowing said composition to remain in contact with said fabric for an effective amount of time before said fabric is washed and/or rinsed.

12. A process according to claim 1 wherein said composition comprising chlorine dioxide and peroxygen bleach, is packaged in a multi-compartment container comprising at least a first compartment and a second compartment, wherein said first compartment contains a composition comprising a chlorine dioxide precursor and wherein said second compartment contains a composition comprising a chlorine dioxide activator.

13. A process according to claim 12 wherein the chlorine dioxide precursor of the composition is selected from the group consisting of sodium chlorite (NaClO₂), sodium chlorate (NaClO₃), potassium chlorite (KClO₂), potassium chlorate (KClO₃), lithium chlorite (LiClO₂), lithium chlorate (LiClO₃), chlorous acid (HClO₂) or chloric acid (HClO₃).

14. A process according to claim 13 wherein the chlorine dioxide precursor comprises sodium chlorite or sodium chlorate.

15. A process according to claim 13 wherein the chlorine dioxide precursor of the composition, in the first compartment, is comprised from 0.005% to 10% by weight of the total composition.

16. The process according to claim 13 wherein the chlorine dioxide precursor of the composition, in the first compartment, is comprised from 0.01% to 5% by weight of the total composition.

17. The process according to claim 13 wherein the chlorine dioxide precursor of the composition, in the first compartment, is comprised from 1% to 3% by weight of the total composition.

18. The process according to claim 12 wherein the chlorine dioxide activator of the composition comprises a source of acidity or an acid.

19. The process according to claim 18 wherein the chlorine dioxide activator of the composition comprises citric acid or oxalic acid.
